(19) United States
(12) Patent Application Publication
(10) Pub. No.: US 2026/0329362 A1
(43) Pub. Date: Oct. 22, 2026

(54) POWER MANAGEMENT ADVISOR FOR AN INTERACTIVE DIGITAL ENVIRONMENT

(71) Applicant: Kyndryl, Inc., New York, NY (US)

(72) Inventor: Cesar Augusto Rodriguez Bravo, Alajuela (CR)

(21) Appl. No.: 19/185,407

(22) Filed: Apr. 22, 2025

(51) Int. Cl. G06F 1/3212

(52) U.S. Cl. CPC G06F 1/3212

(57) ABSTRACT

Embodiments relate to a power management advisor for an interactive digital environment. An aspect includes obtaining a remaining power of a virtual device for engaging in an interactive digital environment, where the virtual device is configured to facilitate interactions associated with the interactive digital environment. An aspect includes determining time periods for the interactions in accordance with the remaining power of the virtual device, wherein the time periods correlate to operational time of the virtual device for the interactions based on the remaining power of the virtual device. An aspect includes presenting selectable options having the interactions juxtaposed with the time periods for operating the virtual device for the remaining power in the interactive digital environment and causing the virtual device to join the interactive digital environment with a selected option of the selectable options.

### BACKGROUND

The present invention generally relates to computer systems, and more specifically, to computer-implemented methods, computer systems, and computer program products configured and arranged for providing a power management advisor for interactive digital environments including virtual reality, augmented reality, and extended reality environments.

Virtual reality (VR) is an experience where users are fully immersed in a virtual world, unable to see the surrounding physical space. Augmented reality (AR) focuses on augmenting the physical world with digital artifacts, images, videos, and/or experiences overlayed with computer-generated images and three-dimensional (3D) models. Mixed reality (MR) combines both virtual reality and augmented experiences. All three technologies are part of the broader category of extended reality (XR).

### SUMMARY

Embodiments of the present invention are directed to computer-implemented methods for a power management advisor for interactive digital environments including virtual reality, augmented reality, and extended reality environments. A non-limiting computer-implemented method includes obtaining a remaining power of a virtual device for engaging in an interactive digital environment, where the virtual device is configured to facilitate interactions associated with the interactive digital environment. The method includes determining time periods for the interactions in accordance with the remaining power of the virtual device, where the time periods correlate to operational time of the virtual device for the interactions based on the remaining power of the virtual device. Also, the method includes presenting/displaying selectable options including the interactions juxtaposed with the time periods for operating the virtual device for the remaining power in the interactive digital environment and causing the virtual device to join the interactive digital environment with a selected option of the selectable options.

Other embodiments of the present invention implement features of the above-described methods in computer systems and computer program products.

Additional technical features and benefits are realized through the techniques of the present invention. Embodiments and aspects of the invention are described in detail herein and are considered a part of the claimed subject matter. For a better understanding, refer to the detailed description and to the drawings.

### BRIEF DESCRIPTION OF THE DRAWINGS

The specifics of the exclusive rights described herein are particularly pointed out and distinctly claimed in the claims at the conclusion of the specification. The foregoing and other features and advantages of the embodiments of the invention are apparent from the following detailed description taken in conjunction with the accompanying drawings in which:

FIG. 1 depicts a block diagram of an example computer system for use in conjunction with one or more embodiments of the present invention;

FIG. 2 depicts a block diagram of an example system with a power management advisor for dynamically generating options for completing a session in an interactive digital environment in accordance with remaining battery power according to one or more embodiments of the present invention;

FIG. 3 is a flowchart of a computer-implemented method for a power management advisor for dynamically generating options for completing a session in an interactive digital environment in accordance with remaining battery power, presenting the selectable options to a user, and causing a virtual reality device to operate based on the selected option according to one or more embodiments of the present invention;

FIG. 4 depicts an example illustration of selectable options based on the remaining battery power according to one or more embodiments of the present invention;

FIG. 5 depicts an example illustration of selectable options based on the remaining battery power according to one or more embodiments of the present invention;

FIG. 6 depicts an example illustration of selectable options based on the remaining battery power according to one or more embodiments of the present invention;

FIG. 7 is a flowchart of a computer-implemented method according to one or more embodiments of the present invention;

FIG. 8 depicts a cloud computing environment according to one or more embodiments of the present invention; and

FIG. 9 depicts abstraction model layers according to one or more embodiments of the present invention.

### DETAILED DESCRIPTION

One or more embodiments are configured and arranged to dynamically provide a power management advisor for interactive digital environments including virtual reality, augmented reality, and extended reality environments. According to one or more embodiments, the power management advisor is configured to perform analysis and calculations to determine the conditions in which the user is able to successfully complete a session (e.g., a virtual meeting, a game, etc.) using virtual reality equipment with a given amount of remaining battery power.

Virtual reality is a simulated experience that can employ tracking and three-dimensional (3D) near-eye displays to offer the user an immersive feel of a virtual world. Applications of virtual reality may include education, business, meetings, entertainment particularly video games, etc. Other distinct types of virtual reality technology include augmented reality and mixed reality, sometimes referred to as extended reality. Virtual reality is an experience where users are fully immersed in a virtual world, unable to see the surrounding physical space. Augmented reality is the experience nearest to the physical end of the virtuality continuum. In augmented reality, users remain fully aware of the physical space but with digital objects or effects overlaying their view. Extended reality is the umbrella term that encompasses all of these technologies. Therefore, extended reality may refer to an experience anywhere along the continuum or multiple experiences collectively.

Virtual reality systems can use virtual reality headsets to generate realistic images, sounds, and other sensations that simulate a user’s physical presence in the virtual reality. Virtual reality equipment enables a user to look around the artificial world, move around in it, and interact with virtual features or items. The simulated experience is commonly created by virtual reality headsets including, for example, a head-mounted display with a small screen in front of the eyes. In addition to virtual reality headsets, virtual reality equipment may include various electronic equipment with sensors and actuators including gloves, headphones, controllers, seats, boards, etc.

There is an increase in the use of virtual reality, augmented reality, and extended reality technologies in the workplace due to the advantages that these technologies can offer including the level of interaction and the immersive and rich environments that workers may already be leveraging and enjoying. However, one of the issues during implementation is that people can suddenly drop from meetings. The reason is that the user headset depleted its remaining battery power. Headsets for these technologies normally have a battery indicator of the remaining battery power and even warnings can be configured to alert users when a given threshold is reached (e.g., 10%, 20%, etc., of remaining battery power). However, while in some cases 20% remaining battery power may be enough for a meeting, in another case the same 20% remaining battery power may not last the entire meeting. The reason is the complexity of the energy usage for the headset.

One or more embodiments provide technical solutions and effects for virtual reality devices (e.g., headsets which can includes smart glasses, etc.) such that users can understand if the remaining battery power of the battery for the virtual reality device is enough to successfully complete an upcoming task or session, such as completing a meeting in an interactive digital environment (e.g., the Metaverse ™ or the like), completing a training in the interactive digital environment (e.g., using augmented reality), etc. According to one or more embodiments, the power management advisor determines the required power for the virtual reality device based on digital environment factors about the digital environment, the user, and the session (e.g., virtual meeting). Digital environment factors refer to the different types of interactions that can occur with respect to the interactive digital environment. In some cases, the digital environment factors require the virtual reality device to utilize one or more sensors to capture information that is utilized in the interactive digital environment. The digital environment factors can relate to the representation and display of the interactive digital environment of the display screen of the virtual reality device. The interactions can be passively performed by the virtual reality device such as capturing an image of the physical world on the display screen of the virtual reality device, and/or actively performed by the user such as user inputs of gestures, screen sharing, voice inputs, eye tracking inputs, etc. The power management advisor informs the user about the selectable options, in light of the digital environment factors related to interactions, to complete the meeting with the current battery power of the virtual reality device. The power management advisor provides selectable options to the user about the duration of the remaining battery power based on the available settings of the interactive digital environment.

Interactive digital environments can include any interactive communication environment in which users can communicate and interact in real time or near real time with each other. Interactive digital environments can include various types of computing environments, which may be computer generated environments that require computer systems/equipment to access and interact. For example, one could not access and operate in an interactive digital environment with a simple pen/pencil and sheet of paper, as understood by one of ordinary skill in the art. Interactive digital environments can include virtual reality, extended reality, augmented reality, gaming environments of a gaming systems, chat environments, etc. Interactive digital environments allow a communication, such as an audio communication (i.e., voice), presentation of a screen (e.g., screen sharing), avatar movements/gestures, and/or text communication performed by (or from) a first user to be automatically output in real time, for example, on a display and/or on speakers to a second user without requiring the second user to take an action to receive the output.

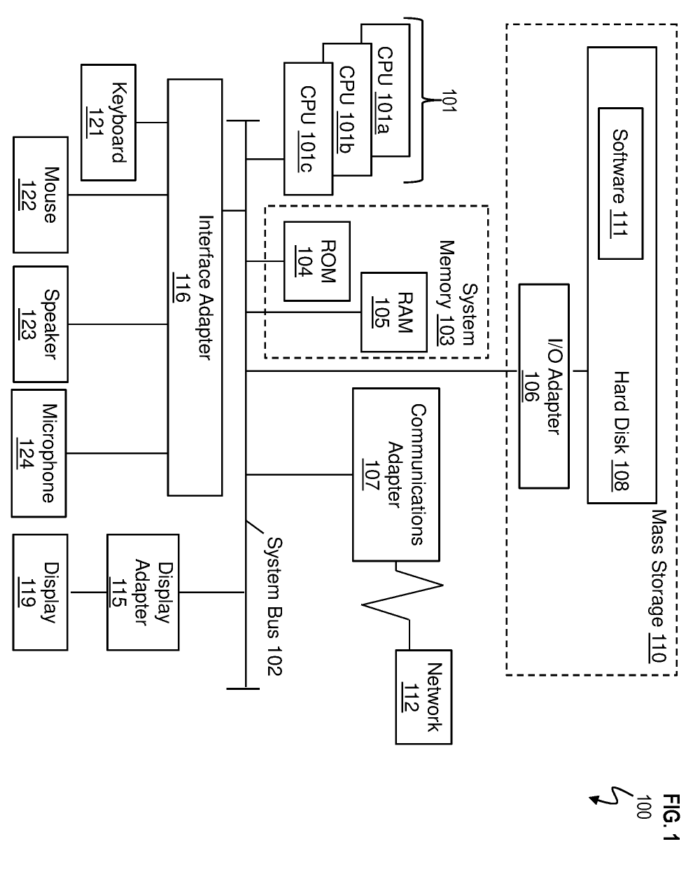

Turning now to FIG. 1, a computer system 100 is generally shown in accordance with one or more embodiments of the invention. The computer system 100 can be an electronic, computer framework comprising and/or employing any number and combination of computing devices and networks utilizing various communication technologies, as described herein. The computer system 100 can be easily scalable, extensible, and modular, with the ability to change to different services or reconfigure some features independently of others. The computer system 100 may be, for example, a server, desktop computer, laptop computer, tablet computer, or smartphone. In some examples, computer system 100 may be a cloud computing node. Computer system 100 may be described in the general context of computer system executable instructions, such as program modules, being executed by a computer system. Generally, program modules may include routines, programs, objects, components, logic, data structures, and so on that perform particular tasks or implement particular abstract data types. Computer system 100 may be practiced in distributed cloud computing environments where tasks are performed by remote processing devices that are linked through a communications network. In a distributed cloud computing environment, program modules may be located in both local and remote computer system storage media including memory storage devices.

As shown in FIG. 1, the computer system 100 has one or more central processing units (CPU(s)) 101a, 101b, 101c, etc., (collectively or generically referred to as processor(s) 101). The processors 101 can be a single-core processor, multi-core processor, computing cluster, or any number of other configurations. The processors 101, also referred to as processing circuits, are coupled via a system bus 102 to a system memory 103 and various other components. The system memory 103 can include a read only memory (ROM) 104 and a random access memory (RAM) 105. The ROM 104 is coupled to the system bus 102 and may include a basic input/output system (BIOS) or its successors like Unified Extensible Firmware Interface (UEFI), which controls certain basic functions of the computer system 100. The RAM is read-write memory coupled to the system bus 102 for use by the processors 101. The system memory 103 provides temporary memory space for operations of said instructions during operation. The system memory 103 can include random access memory (RAM), read only memory, flash memory, or any other suitable memory systems.

The computer system 100 comprises an input/output (I/O) adapter 106 and a communications adapter 107 coupled to the system bus 102. The I/O adapter 106 may be a small computer system interface (SCSI) adapter that communicates with a hard disk 108 and/or any other similar component. The I/O adapter 106 and the hard disk 108 are collectively referred to herein as a mass storage 110.

Software 111 for execution on the computer system 100 may be stored in the mass storage 110. The mass storage 110 is an example of a tangible storage medium readable by the processors 101, where the software 111 is stored as instructions for execution by the processors 101 to cause the computer system 100 to operate, such as is described herein below with respect to the various Figures. Examples of computer program product and the execution of such instruction is discussed herein in more detail. The communications adapter 107 interconnects the system bus 102 with a network 112, which may be an outside network, enabling the computer system 100 to communicate with other such systems. In one embodiment, a portion of the system memory 103 and the mass storage 110 collectively store an operating system, which may be any appropriate operating system to coordinate the functions of the various components shown in FIG. 1.

Additional input/output devices are shown as connected to the system bus 102 via a display adapter 115 and an interface adapter 116. In one embodiment, the adapters 106, 107, 115, and 116 may be connected to one or more I/O buses that are connected to the system bus 102 via an intermediate bus bridge (not shown). A display 119 (e.g., a screen or a display monitor) is connected to the system bus 102 by the display adapter 115, which may include a graphics controller to improve the performance of graphics intensive applications and a video controller. A keyboard 121, a mouse 122, a speaker 123, a microphone 124, etc., can be interconnected to the system bus 102 via the interface adapter 116, which may include, for example, a Super I/O chip integrating multiple device adapters into a single integrated circuit. Suitable I/O buses for connecting peripheral devices such as hard disk controllers, network adapters, and graphics adapters typically include common protocols, such as the Peripheral Component Interconnect (PCI) and the Peripheral Component Interconnect Express (PCIe). Thus, as configured in FIG. 1, the computer system 100 includes processing capability in the form of the processors 101, storage capability including the system memory 103 and the mass storage 110, input means such as the keyboard 121, the mouse 122, and the microphone 124, and output capability including the speaker 123 and the display 119.

In some embodiments, the communications adapter 107 can transmit data using any suitable interface or protocol, such as the internet small computer system interface, among others. The network 112 may be a cellular network, a radio network, a wide area network (WAN), a local area network (LAN), or the Internet, among others. An external computing device may connect to the computer system 100 through the network 112. In some examples, an external computing device may be an external webserver or a cloud computing node.

It is to be understood that the block diagram of FIG. 1 is not intended to indicate that the computer system 100 is to include all of the components shown in FIG. 1. Rather, the computer system 100 can include any appropriate fewer or additional components not illustrated in FIG. 1 (e.g., additional memory components, embedded controllers, modules, additional network interfaces, etc.). Further, the embodiments described herein with respect to computer system 100 may be implemented with any appropriate logic, wherein the logic, as referred to herein, can include any suitable hardware (e.g., a processor, an embedded controller, or an application specific integrated circuit, among others), software (e.g., an application, among others), firmware, or any suitable combination of hardware, software, and firmware, in various embodiments.

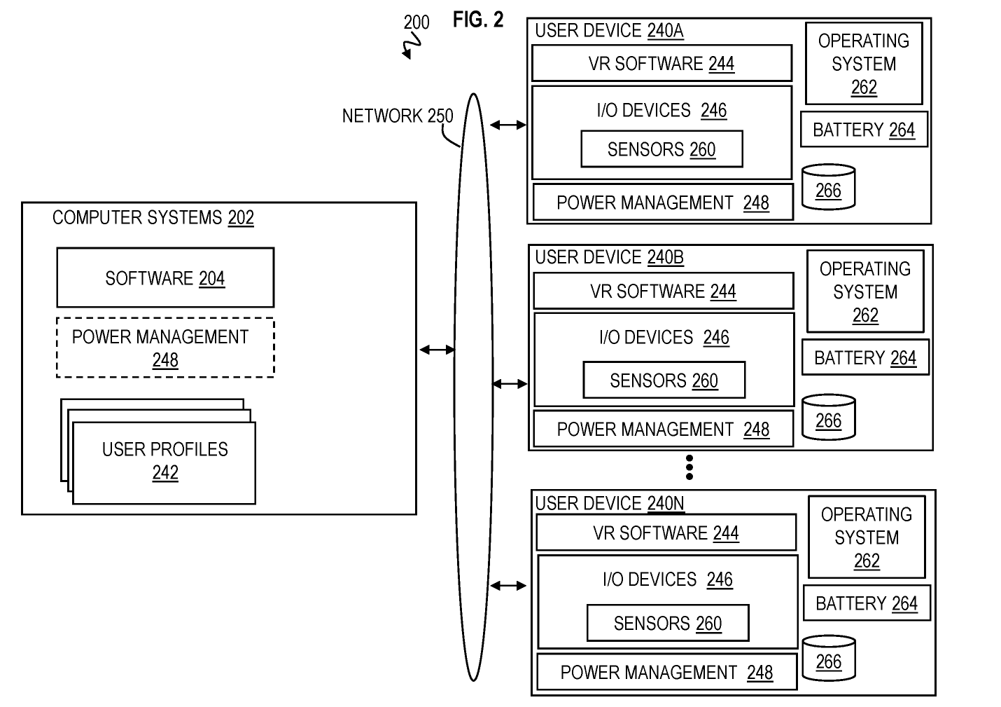

FIG. 2 depicts a block diagram of an example system 200 with a power management advisor for dynamically generating options for completing a session in an interactive digital environment in accordance with remaining battery power, presenting the options to a user, and causing a virtual reality device to operate based on the selected option according to one or more embodiments. The system 200 includes one or more computer systems 202 configured to communicate over a network 250 with many different computer systems as virtual reality devices, such as a user device 240A for providing the interactive digital environment to a user, a user device 240B for providing the interactive digital environment to a user, through a user device 240N for providing the interactive digital environment to a user. The user devices 240A, 240B, through 240N can generally be referred to as user devices 240 and are utilized to access the interactive digital environment including virtual reality, augmented reality, extended reality, such that these technologies can be used for any type of session including interactive digital meetings, video gaming, entertainment, etc., offered by the computer system 202. The user devices 240 represent the virtual reality equipment. A session refers to a virtual event or gathering that occurs in the interactive digital environment in which the user devices 240A, 240B, and 240N can join the session. In some example scenarios, the session is for a particular user activity such as a virtual meeting that occurs in the interactive digital environment.

For explanation purposes and not limitation, some example scenarios of the interactive digital environment may discuss virtual reality. It should be appreciated that one or more embodiments are not limited to examples utilizing virtual reality, and the discussions apply by analogy to any real-time interactive communication environment. Some example scenarios may identify a user of the user device 240A for illustration purposes.

In one or more embodiments, the user device 240 can be representative of any type of virtual reality equipment, gaming equipment, and/or electronic device for experiencing a virtual environment. The virtual reality equipment can include a virtual reality headset, smart glasses (or other wearables), etc. The user devices 240 can include various software and hardware components including virtual reality software 244 for general virtual reality operations known by one of ordinary skill in the art. Although virtual reality is utilized as an example, the virtual reality software 244 can include gaming software of well-known gaming systems, digital meeting software, augmented reality software, extended reality software, etc. The user devices 240 can include one or more input/output (I/O) devices 246 including microphones, displays, sensors 260, and other peripherals. A user device 240 can include numerous sensors 260 including image sensors including cameras, motion sensors including inertial mass unit sensors, light sensors, accelerometers, gyroscopes, proximity sensors, infrared sensors, magnetic position sensors, depth sensors, etc. The user devices 240 can be coupled to a controller, such as a handheld controller. The user devices 240 include an operating system, batteries, and any other software and hardware components known for operating as virtual reality equipment.

The computer systems 202, user devices 240, software 204, virtual reality software 244, power management advisor module 248, etc., can include functionality and features of the computer system 100 in FIG. 1 including various hardware components and various software applications such as software 111 which can be executed as instructions on one or more processors 101 in order to perform actions according to one or more embodiments of the invention. The software 204 and power management software module 248 can include, be integrated with, and/or call various other pieces of software, algorithms, application programming interfaces (APIs), etc., to operate as discussed herein. The software 204 is representative of numerous software applications designed to work together to provide virtual reality services as understood by one of ordinary skill in the art. Each of the users of the user devices 240A-240N may have registered with registration and authentication software for a user account in order to utilize the virtual reality services provided by computer systems 202, and each of the users has its own user account in its own user profile in user profiles 242. The network 250 can be a wired and/or wireless communication network over which the computer systems communicate.

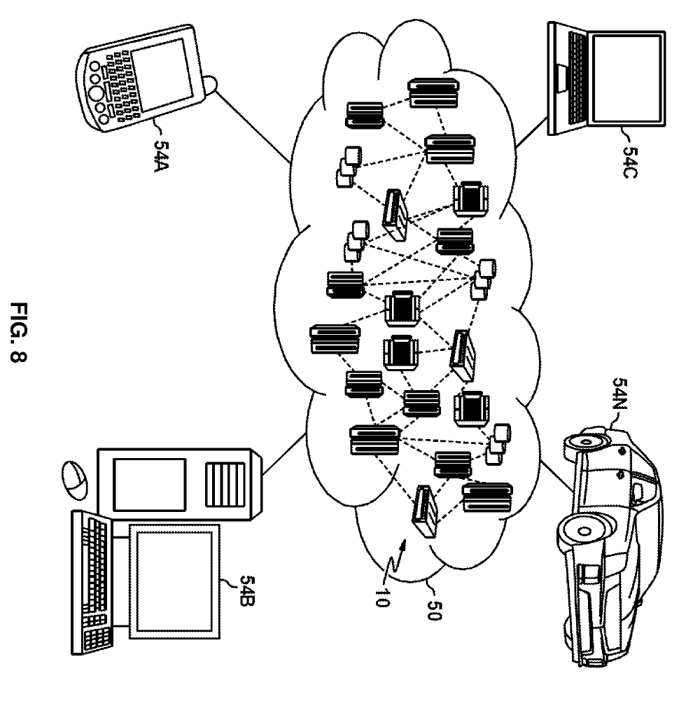

The computer systems 202 can be representative of numerous computer systems and/or distributed computer systems configured to provide virtual reality services to users of the user devices 240. The computer systems 202 can be part of a cloud computing environment such as a cloud computing environment 50 depicted in FIG. 8, as discussed further herein.

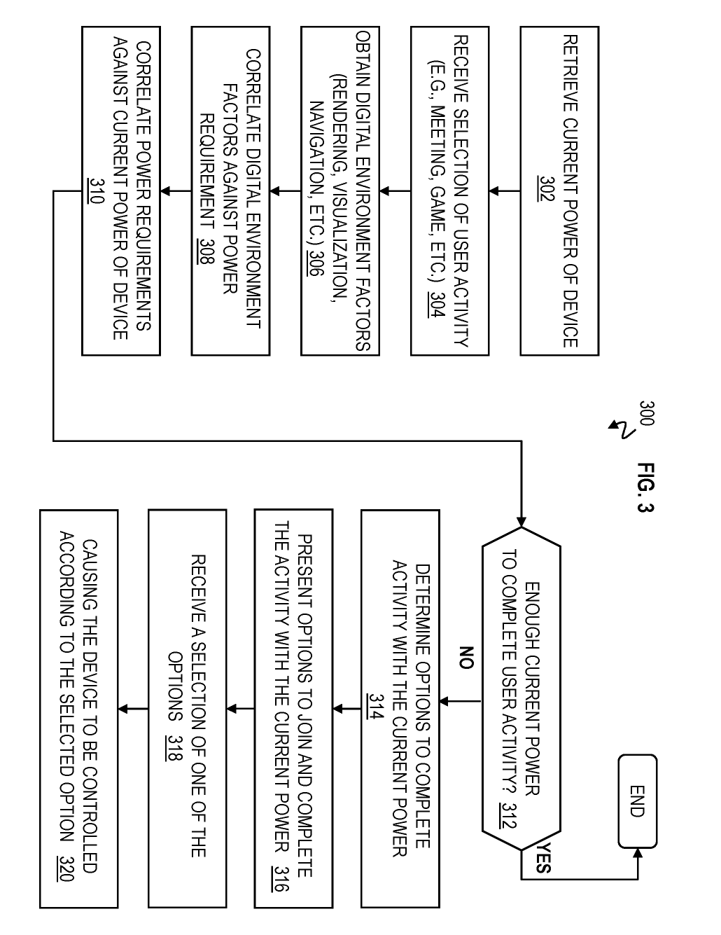

FIG. 3 is a flowchart of a computer-implemented method 300 for a power management advisor for dynamically generating options for completing a session in an interactive digital environment in accordance with remaining battery power, presenting/displaying the selectable options to a user, and causing a virtual reality device to operate based on the selected option according to one or more embodiments. The computer-implemented method 300 can be executed by the power management advisor module 248 of the user device 240 that connects to the computer system 202 for a session in the interactive digital environment. One or more portions of the power management advisor module 248 can be included or represented on the computer systems 202, according to one or more embodiments. The power management advisor module 248 can include, be integrated with, communicate with (using standard protocols), and/or call various other pieces of software, algorithms, application programming interfaces (APIs), etc., to operate as discussed herein. The power management advisor module 248 includes at least some of the computer code involved in performing the novel methods according to one or more embodiments. Reference can be made to any figures discussed herein. For illustration purposes, an example scenario is discussed in which the user of, for example, the user device 240A has an upcoming session, which can be an interactive digital meeting (or virtual meeting), a digital game, etc.

At block 302 of the computer-implemented method 300, the power management advisor module 248 of user device 240A is configured to retrieve the remaining battery power of the battery 264 of the user device 240A. The current battery power refers to the remaining battery power of the battery 264 (or battery pack) for the user device 240A. Current battery power, remaining battery power, and battery power can be used interchangeably and refer to an amount of energy stored in the battery 264 of a user device 240 and available for use. In one or more embodiments, the power management advisor module 248 can query the operating system 262 of the user device 240A for the current battery power of the battery 264, and the operating system 262 provides the status of the battery 264, which may be 30% full for instance. The power management advisor module 248 may periodically query (e.g., pull from) the operating system 262 for the status of the battery 264, and/or the operating system 262 can push the status of the battery 264. In one or more embodiments, the power management advisor module 248 can parse software apps on or coupled to the user device 240A for upcoming sessions which are user activities. For example, the power management advisor module 248 can parse calendar applications, text messages, emails, etc., for an upcoming session in the interactive digital environment. For instance, the power management advisor module 248 may determine that a calendar entry is for an upcoming interactive digital meeting.

At block 304, the power management advisor module 248 of user device 240A is configured to receive (e.g., user input) selection of a session and/or determine that a session is scheduled in the future (e.g., 5 minutes, 10 minutes, 15 minutes, 30 minutes 45 minutes, etc., in the future). In one or more embodiments, the session may be a digital meeting that is upcoming, and the power management advisor module 248 captures the duration of the digital meeting. For example, the duration of the digital meeting may be provided in a calendar entry (e.g., as a meeting invite), text message, email, etc.; the start time and ending time of the digital meeting may be provided such that the power management advisor module 248 can calculate the duration (e.g., 60 minutes). In one or more embodiments, the power management advisor module 248 can estimate the duration in accordance with past occurrences of the session, such as past meetings, past calendar invites, etc. In one or more embodiments, the power management advisor module 248 can request the duration of the session (e.g., using a session identification (ID) or meeting ID) from the software 204 of the computer systems 202 hosting the interactive digital environment for the user devices 240, and/or make the request by proxy via the virtual reality software 244.

Further, in some embodiments, the power management advisor module 248 may have an established communication protocol such that the power management advisor module 248 of user device 240 can communicate directly with the software 204 of the computer systems 202 over the network 250 in order to request the duration of the session (e.g., using an identification such as a meeting identification). In some implementations, the power management advisor module 248 of user device 240 may not have an established communication protocol, and the power management advisor module 248 requests/instructs the virtual reality software 244 (which has an established communication protocol, for example, with an authentication method) to communicate with the software 204 of the computer systems 202 over the network 250 in order to obtain the duration of the session.

At block 306, the power management advisor module 248 of user device 240A is configured to obtain digital environment factors for the upcoming session. In one or more embodiments, power management advisor module 248 may query the virtual reality software 244, the software 204 of the computer systems 202 that host the interactive digital environment for the user devices 240, and/or the calendar entry to obtain one or more digital environment factors. In some implementations, the power management advisor module 248 of user device 240 may communicate directly with the software 204 of the computer systems 202 over the network 250 to obtain the digital environment factors. In some implementations, the power management advisor module 248 requests/instructs the virtual reality software 244 (which has an established communication protocol) to communicate with the software 204 of the computer systems 202 over the network 250 in order to obtain the digital environment factors.

As discussed herein, the power management advisor module 248 can cause any of the digital environment factors to be disabled, which includes disabling one or more sensors of the user device 240, in order to meet the power requirements of the user device 240 such that the session (e.g., interactive digital meeting) can be completed with the remaining battery power. The digital environment factors refer to features or settings that allow interactions (e.g., actions) in the interactive digital environment, where some features or settings can be turned off on the user device 240 (e.g., external sensors 260 (e.g., external cameras) can be disabled when disabling augmented reality), thereby reducing power usage. Various digital environment factors that are supported by the software 204 and VR software 244 for the interactive digital environment can include but are not limited to the following:
A) Technologies supported by the interactive digital environment including virtual reality, augmented reality, and extended reality. The power management advisor module 248 is configured to request and gather information from the interactive digital environment (e.g., from software 204 of computer systems 202, the VR software 244, or the meeting invite) to determine the options available for the meeting, for example, augmented reality enabled, virtual reality only, voice, video sharing, avatar represented, movement of the avatar, etc. For instance, with augmented reality enabled, the user of user device 240A can see her pen on her physical desk as well as the interactive digital environment that includes the other users of user devices 240B and 240C. With movement of the avatar, the user device 240A tracks the movements/actions of the user in the physical world with the sensors 260 and projects these movements/actions into the interactive digital environment by moving the avatar accordingly. Virtual reality only excludes augmented reality and extended reality, thereby disabling sensors 260 associated with the same and avoiding the processing of data associated with the same, which saves the remaining battery power of the user device 240A.
B) Supported graphic options: The power management advisor module 248 is configured to request and gather information from the interactive digital environment (e.g., from software 204 of computer systems 202, the VR software 244, or the meeting invite) to determine supported graphic options such as display in two-dimensions (2D), display in three-dimensions (3D), etc. This provides the rendering requirements of the interactive digital environment on the user device 240A, where 2D rendering on the user device 240A requires less processing power (corresponding to consuming less battery power and less CPU usage) than 3D rendering on the user device 240A. The power management advisor module 248 can provide time periods for graphic options to the user in accordance with the remaining battery power as discussed herein.
C) Rendering options: The power management advisor module 248 is configured to request and gather information from the interactive digital environment (e.g., from software 204 of computer systems 202, the VR software 244, or the meeting invite) to determine rendering options for the display on the user device 240A of the user. For example, the rendering options may include low definition (e.g., which uses the least amount of battery power), standard definition (which uses more battery power than low definition but less battery power than high definition), high definition (e.g., which uses more battery power than low and standard definition), etc., on the user device 240A. From the lowest battery power usage to the highest battery power usage, the resolution rendered on the user device 240A may include 360p, 480p, 720p, 1080p, and 4K. The power management advisor module 248 can provide time periods for rendering options (e.g., lowest resolution to highest resolution) to the user in accordance with the remaining battery power as discussed herein.
D) Visualization options: The power management advisor module 248 is configured to request and gather information from the interactive digital environment (e.g., from software 204 of computer systems 202, the VR software 244, or the meeting invite) to determine visualization options of the interactive digital environment in which the session (e.g., interactive digital meeting) is to occur. The visualization options can include first person views, third person views, etc., for display on the user device 240A. For example, during the first person view, the user of user device 240A does not need to display her avatar which reduces consumption of battery power. During third person view, the user of user device 240A displays her avatar on the display of user device 240A which increases consumption of battery power as compared to first person. The power management advisor module 248 can provide time periods for visualization options to the user in accordance with the remaining battery power as discussed herein.
E) Check whether spectator mode is available: The power management advisor module 248 is configured to request and gather information from the interactive digital environment (e.g., from software 204 of computer systems 202, the VR software 244, or the meeting invite) to determine if spectator mode is available in the interactive digital environment. The power management advisor module 248 determines if spectator mode is available as a low energy/power consumption mode for the user device 240A in order to reduce consumption of battery power to complete the session (e.g., the meeting). Spectator mode is a feature that allows a user to watch, for example, the meeting, without participating. It is also known as observer mode. The power management advisor module 248 can utilize spectator mode in which the avatar of the user is not rendered on the display and the avatar is not visually seen, thereby saving battery power on the user device 240A. The power management advisor module 248 can provide time periods for spectator mode to the user in accordance with the remaining battery power as discussed herein.
F) Audio options: The power management advisor module 248 is configured to request and gather information from the interactive digital environment (e.g., from software 204 of computer systems 202, the VR software 244, or the meeting invite) to determine available audio options for the user device 240A. Example audio options can include spatial audio, 3D audio, stereo audio, environmental audio, etc. Spatial audio and environmental audio require more sensors 260 thereby consuming more battery power of the user device 240A as compared to, for example, stereo audio. Spatial audio requires more CPU processing by the user device 240A, because the audio may change as the avatar of the user moves around in the interactive digital environment and/or as the avatar changes its focus. Spatial audio is a technology that creates a 3D listening experience by making sounds seem like they are coming from different directions and distance, thereby rendering the audio/sounds based on proximity/distance of the people, such that people far away from the avatar have a lower volume compared to people closer to the avatar. The power management advisor module 248 can provide time periods for audio options to the user in accordance with the remaining battery power as discussed herein.
G) Avatar body settings: The power management advisor module 248 is configured to request and gather information from the interactive digital environment (e.g., from software 204 of computer systems 202, the VR software 244, or the meeting invite) to determine available avatar body settings for the avatar representing the user of the user device 240A. Example avatar body settings can include a full body avatar, a half body avatar, head avatar, etc. The full body avatar may include head, body, and legs and could optionally include hands and feet. The half body avatar may include head and body, but no legs. The battery power consumption from lowest to highest battery consumption on the user device 240A includes, for example, the head avatar with the lowest battery consumption, the half body avatar with a higher battery power consumption than the head avatar but lower battery consumption than the full body avatar, and the full body avatar with the highest battery power consumption compared to the half body avatar and the head avatar. The power management advisor module 248 can provide time periods for avatar body settings to the user in accordance with the remaining battery power as discussed herein.
H) Avatar movement settings: The power management advisor module 248 is configured to request and gather information from the interactive digital environment (e.g., from software 204 of computer systems 202, the VR software 244, or the meeting invite) to determine avatar movement settings for the avatar of the user of the user device 240A. Example avatar movement settings for the avatar of the user can include floating, walking, head movements, hand movements, etc., which can be captured by sensors 260 and represented in the interactive digital environment.
The power management advisor module 248 gathers the available movements to determine less power intense movement settings such as, for example, a floating static avatar consumes less battery power and less processing power (and is faster) than a walking avatar because the user device 240A (e.g., the headset) does not need to use sensors 260 to determine movement of the user. Particularly, rendering the legs of a walking avatar consumes more battery power of the user device 240A than the static avatar that floats in place. Capturing hand, feet, and head movements all require sensors 260 and additional processing, thereby requiring additional battery power. Accordingly, the power management advisor module 248 can provide time periods for avatar movement settings to the user in accordance with the remaining battery power as discussed herein.
I) Avatar display settings: The power management advisor module 248 is configured to request and gather information from the interactive digital environment (e.g., from software 204 of computer systems 202, the VR software 244, or the meeting invite) to determine what are the display settings for the avatar. Example avatar display settings include displaying the full avatar, guest avatars, etc., in order to display other avatars that are not the user of the user device 240A. In one case, the power management advisory module 248 can provide options to avoid displaying guest avatars even though their voice can be heard, and this reduces the processing of the user device 240A resulting in a decrease in battery power consumption. The power management advisor module 248 can provide time periods for avatar display settings to the user in accordance with the remaining battery power as discussed herein.

Referring to FIG. 3, at block 308, the power management advisor module 248 of user device 240A is configured to correlate the digital environment factors of the interactive digital environment against power requirements on the user device 240A for each of the digital environment factors. In one or more embodiments, a repository 266 includes the power requirements of the user device 240A for each of the digital environment factors, which means that the power requirements of battery consumption for each interactive digital environment are provided for each increment of time (e.g., 5 minutes, 10 minutes, 15 minutes, 20 minutes, 30 minutes, 45 minutes, 60 minutes, 2 hours, 3 hours, etc.). In one or more embodiments, the power requirements of battery consumption for each of the digital environment factors can be arranged in a chart in the repository 266, which shows the relationship between a given digital environment factor and different increments of time for power requirements of battery consumption. For example, a full body avatar may have a 2% power requirement of battery consumption for 10 minutes, a 4% power requirement of battery consumption for 15 minutes, a 6% power requirement of battery consumption for 20 minutes, etc. As a result, the power management advisor module 248 determines or estimates using the (historical) data in repository 266 the power requirement of battery consumption for each of the digital environment factors that apply to the interactive digital environment, the meeting invite, etc.

At block 310, the power management advisor module 248 of user device 240A is configured to correlate the determined power requirements for each of the digital environment factors against the remaining battery power of the user device 240A. The power requirements of the digital environment factors can be extrapolated for the given duration of the session (e.g., the duration of the meeting). In the example scenario, it is assumed that the duration of the meeting is 60 minutes (1 hour) and the remaining battery power is 30% of full battery power.

In one or more embodiments, the power management advisor module 248 is configured to compare the power requirements for each of the digital environment factors to the remaining battery power of the user device 240A to determine whether the power requirements for an increment of time (e.g., 60 minutes) matching the duration (e.g., 60 minutes) of the meeting is less than or equal to the remaining battery power. For example, the power requirement for augmented reality (which uses external sensors 260) for 60 minutes (as the duration of the meeting) might require 60% battery power, while the power requirement for virtual reality (which does not require those same external sensors 260) might require 30% battery power. In this example, the power management advisor module 248 is configured to display the results to the user of the user device 240A, so that a selection can be made the user.

Accordingly, the power management advisor module 248 determines which of the digital environment factors are candidates having power requirements that can function for the entire duration (e.g., 60 minutes) of the meeting (e.g., the session). The power management advisor module 248 is configured to determine various combinations of the candidate digital environment factors that can be combined such that the user device 240A can function for the entire duration (e.g., 60 minutes) of the meeting, where there can be a first combination of digital environment factors, a second combination of digital environment factors, a third combination of digital environment factors, etc. In one or more embodiments, the power requirements of different digital environment factors can be summed for the given duration of the meeting such that the total power requirements of a given combination of digital environment factors is less than or equal to the remaining battery power. This process can continue until there are no more available combinations. Although not explicitly identified as a digital environment factor, it is noted that any selectable options discussed herein include operation of the display and microphone of the user device 240 unless explicitly stated otherwise.

In one or more embodiments, the power management advisor module 248 may call and/or be coupled to an algorithm configured to perform combinatorial optimization to achieve the different combinations of candidate digital environment factors that meet the duration of the meeting for the remaining battery power, such as a first combination of digital environment factors, a second combination of digital environment factors, a third combination of digital environment factors, etc. Example algorithms can include a genetic algorithm, a population-based algorithm, a hill climbing algorithm, a Bayesian optimization, etc.

At block 312, the power management advisor module 248 of user device 240A is configured to check whether the user device 240A has enough remaining battery power to complete the session without power management. If yes, the user device 240A has enough remaining battery power to complete the session without power management, the flow ends. For example, the user device may have 100%, 98%, 90%, etc., remaining battery power, which is no problem to complete the session (e.g., interactive digital meeting) with all the digital environment factors for the duration. In one or more embodiments, a battery power threshold can be set (e.g., equal to or above 80% battery power) for which power management options can be skipped when the remaining battery power meets the battery power threshold.

At block 314, the power management advisor module 248 of user device 240A is configured to determine selectable options to complete the session with the remaining battery power of the user device 240A for presentation to the user. In one or more embodiments, the power management advisor module 248 can gather the candidate digital environment factors that had power requirements meeting the remaining battery power for the given duration and the different combinations (e.g., first combination, second combination, third combination, etc.) of candidate digital environment factors that had power requirements meeting the remaining battery power. The candidate digital environment factors and the different combinations (e.g., first combination, second combination, third combination, etc.) of candidate digital environment factors are available options for completing the session.

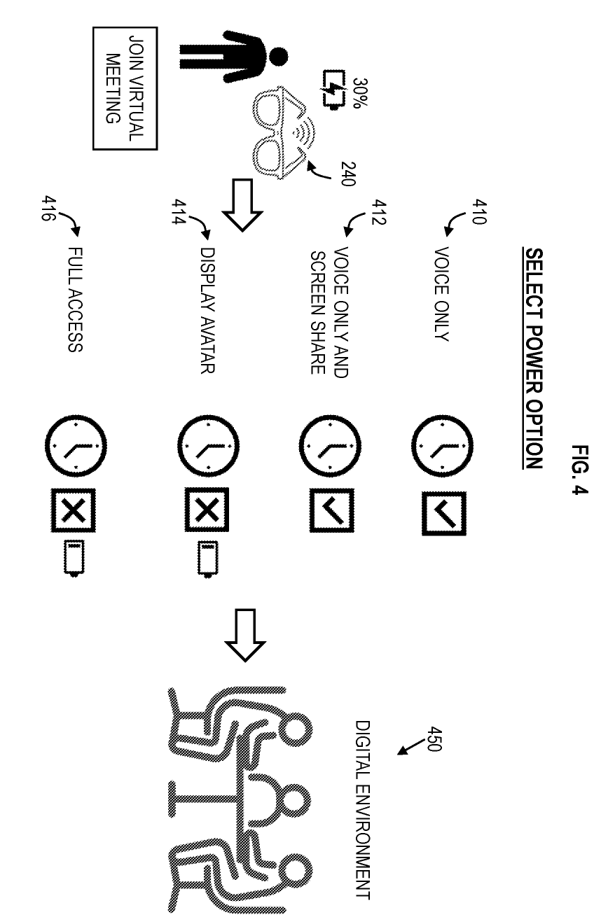

At block 316, the power management advisor module 248 of user device 240A is configured to present selectable options to the user to join and complete the session with the remaining battery power. As noted above, the selectable options presented to the user can include the candidate digital environment factors and the different combinations (e.g., first combination, second combination, third combination, etc.) of candidate digital environment factors as available options for completing the session. In one or more embodiments, the power management advisor module 248 may gather digital environment factors and different combinations that do not have power requirements meeting the duration of the session, so that the user can see these options as well. The selectable options can be displayed on the display of the user device 240A, presented as audio and/or video, etc. The user may use a hand-held controller, voice, hand gestures, eye movement, etc., to select the desired selectable option and join the session. Accordingly, the user of user device 240A does not have to join the meeting uninformed about her ability to complete the meeting but now has selectable options showing the type of user experience that can be achieved with the remaining battery power or for a given time period. For illustration purposes and not limitation, FIGS. 4, 5, and 6 depict examples of selectable options for joining the session, which is a virtual meeting being held in the interactive digital environment.

At block 318, the power management advisor module 248 of user device 240A is configured to receive a selection of one or more selectable options for using the digital environment factors during the session (e.g., virtual meeting) in the interactive digital environment.

At block 320, the power management advisor module 248 of user device 240A is configured to cause the user device 240A to be controlled and/or operate according to the selected option. In one or more embodiments, the power management advisor module 248 can change one or more settings of the VR software 244 in accordance with the selected option, instruct the VR software 244 to change one or more settings in accordance with the selected option, change one or more settings on the user device 240A (e.g., such as disabling one or more sensors 260) in accordance with the selected option, etc.

Accordingly, the present disclosure presents/displays selectable options to the user that account for the power requirements of the interactive digital environment based on various digital environment factors along with the features (e.g., required sensors) of the user device 240. As such, this provides real-time feedback to the user as selectable options such that the user can view and select the possibilities of completing the given session with the remaining battery power (e.g., 30% remaining battery power) of the user device 240.

Although depicted in a particular order, the blocks depicted in FIG. 3 can be, in some embodiments, rearranged, subdivided, and/or combined.

Now turning to FIGS. 4, 5, 6, example illustrations are depicted in which the various selectable options and their associated results are graphically displayed on a user interface to the user on the user device 240. FIG. 4 illustrates selectable options for the candidate digital environment factors and their combinations, where the remaining battery power is, for example, 30%. Example selectable options 410, 412, 414, and 416 are displayed with the type of interactions to the user for the interactive digital environment 450. Selectable option 410 is a voice only option that meets the duration of the meeting. The interactions relate to the user experience in the interactive digital environment 450 and express how the user moves in, relates to, and experiences the interactive digital environment. The interactions of the user are affected by the digital environment factors. For example, with the voice only option, because digital environment factors for augmented reality, display avatar, screen share, etc., are disabled, the sensors 260 associated with these digital environment factors are disabled. The user is only able to interact by voice during the session. Selectable option 412 is a voice and screen share option that meets the duration of the meeting. However, selectable option 414 is a display avatar option that does not meet the duration of the meeting. As noted above, the display avatar option also includes voice although voice is not explicitly displayed. Selectable option 416 is a full access option that does not meet the duration of the meeting. Full access does not limit any type of interactions in the interactive digital environment 450.

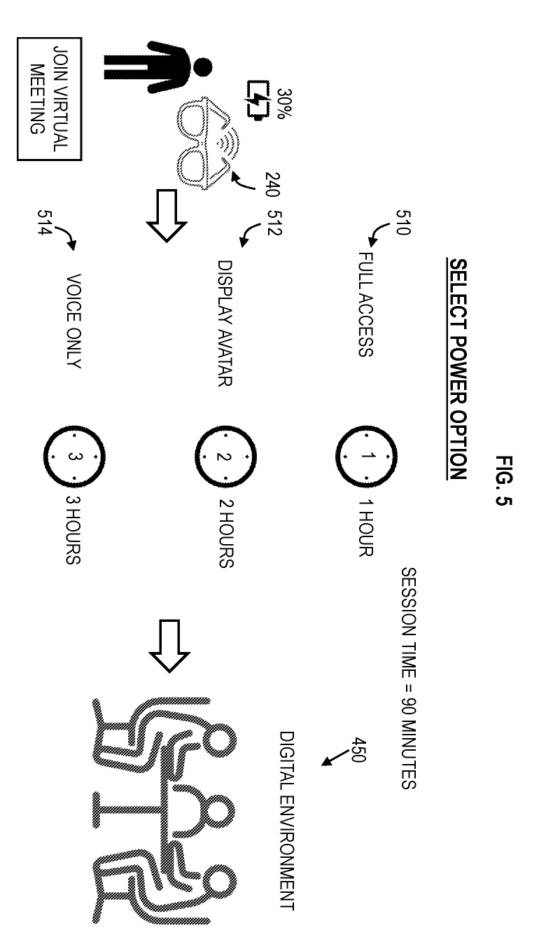

FIG. 5 illustrates selectable options for the candidate digital environment factors and their combinations, where the remaining battery power is, for example, 30%. In this case, the example is based on the time period that each selectable option can be performed by the user device 240 given the remaining battery power. Example selectable options 510, 512, and 514 are displayed to the user for the interactive digital environment 450. Selectable option 510 is a full access/setting option that will last for 1 hour given the remaining battery power of the user device 240. Selectable option 512 is a display avatar option that will last for 2 hours given the remaining battery power of the user device 240. Selectable option 514 is a voice only option that will last for 3 hours given the remaining battery power of the user device 240. In some embodiments, the user interface can show the session time such that the user can determine which selectable options have time periods that can be completed for the duration of the session. In one or more embodiments, the user interface can display a positive indication (e.g., a check mark) beside the selectable options that meet the condition of the duration and a negative indication (e.g., an X mark) beside the selectable options that fail to meet the condition of the duration for the remaining power. In the example illustrated in FIG. 5, the selectable options 512 and 514 with 2 hour and 3 hour time periods respectively can be utilized to meet the duration of a 90 minute session. Conversely, the selectable option 510 with the 1 hour time period cannot be utilized to meet the duration of the 90 minute session.

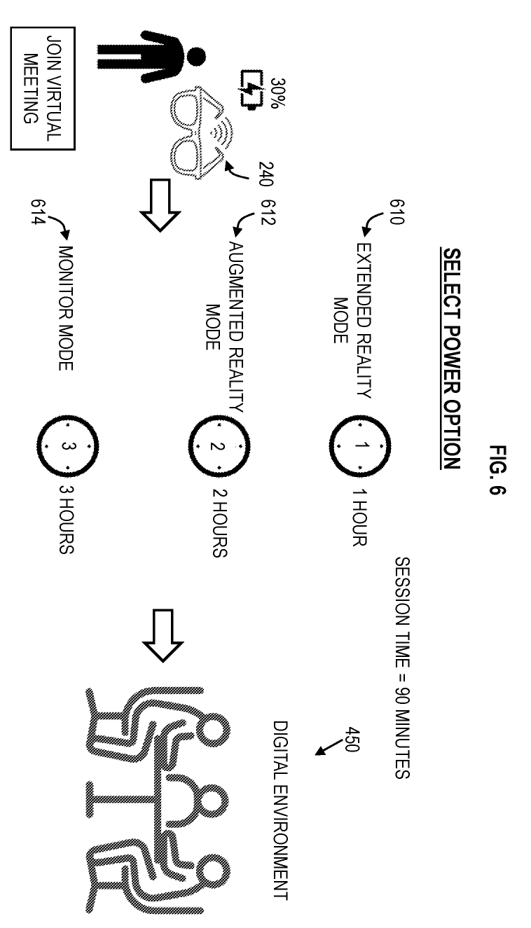

FIG. 6 illustrates selectable options for the candidate digital environment factors and the combinations, where the remaining battery power is, for example, 30%. In this case, the example is based on immersive type for the user experience. Example selectable options 610, 612, and 614 are displayed to the user for the interactive digital environment 450. Selectable option 610 is an extended reality mode that will last for 1 hour given the remaining battery power of the user device 240. Selectable option 612 is an augmented reality mode that will last for 2 hours given the remaining battery power of the user device 240. Selectable option 614 is a monitor only mode that will last for 3 hours given the remaining battery power of the user device 240. In the example illustrated in FIG. 6, the selectable options 612 and 614 with 2 hour and 3 hour time periods respectively can be utilized to meet the duration of a 90 minute session.

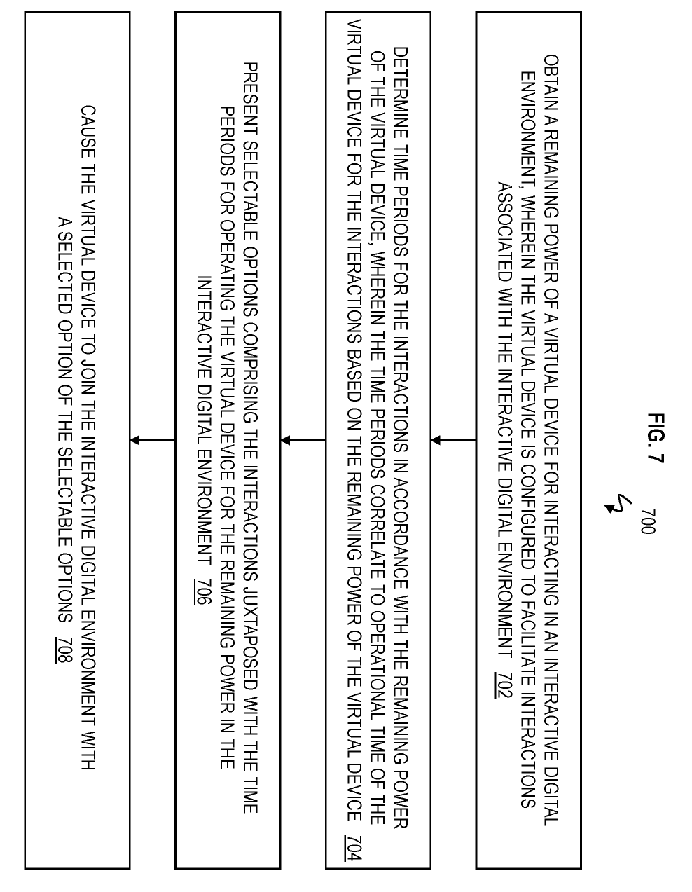

FIG. 7 is a flowchart of a computer-implemented method 700 for a power management advisor for dynamically generating options for completing a session in an interactive digital environment in accordance with remaining battery power, presenting/displaying the selectable options to a user, and causing a virtual reality device to operate based on the selected option according to one or more embodiments. Reference can be made to any figures discussed herein.

At block 702, the power management advisor module 248 is configured to obtain a remaining power (e.g., remaining battery power) of a virtual device (e.g., user device 240) for engaging/interacting in an interactive digital environment (e.g., interactive digital environment 450), where the virtual device is configured to facilitate interactions associated with the interactive digital environment.

At block 704, the power management advisor module 248 is configured to determine (calculate or estimate) time periods for the interactions in accordance with the remaining power of the virtual device (e.g., user device 240), where the time periods correlate to operational time of the virtual device for the interactions based on the remaining power of the virtual device.

At block 706, the power management advisor module 248 is configured to present/display selectable options including the interactions juxtaposed with the time periods for operating the virtual device for the remaining power in the interactive digital environment.

At block 708, the power management advisor module 248 is configured to cause the virtual device (e.g., user device 240) to join the interactive digital environment with a selected option of the selectable options.

According to one or more embodiments, the power management advisor module 248 is configured to obtain a duration of a session (e.g., the length of an upcoming meeting, such as 60 minutes) expected in the interactive digital environment. Determining the (calculated/estimated) time periods for the interactions in accordance with the remaining power of the virtual device comprises determining the time periods for the interactions based on completing a duration (e.g., 60 minutes) of a session expected in the interactive digital environment. Determining the time periods for the interactions in accordance with the remaining power of the virtual device comprises obtaining digital environment factors for the interactive digital environment and determining the time periods for the interactions in accordance with the digital environment factors.

In response to a duration of a session expected in the interactive digital environment, the selectable options display at least one interaction of the interactions having a time period that ensures the remaining power (e.g., the remaining battery power of the user device 240) lasts for the duration of the session expected in the interactive digital environment. In response to a duration of a session expected in the interactive digital environment, the selectable options comprise the (calculated/estimated) time periods indicating how long (or an extent) the remaining power is expected to last for the duration of the session or when the remaining power is expected to fail during the duration of the session. For example, the selectable options can display interactions of full access, avatar movements, voice only, etc., and provide a length of time for each of the types of interactions, such that the selectable options shows the user that full access of all types of interactions will last for 30 minutes although the meeting is scheduled for 60 minutes.

In one or more embodiments, the power management advisor module 248 is configured to, in response to receiving the selected option of the selectable options, control/instruct/cause the virtual device (e.g., user device 240) to operate at least one interaction (e.g., voice and screen sharing) of the interactions corresponding to the selected option in accordance with the remaining power of the virtual device.

Technical solutions and benefits include a novel method and system that determine the required power for a virtual reality device (e.g., headset including smart glasses or other types of wearables) based on unique factors about the interactive digital environment, the user, the session being executed in the interactive environment, etc. As technical solutions and benefits, the system presents the user with selectable options available to complete the session (e.g., meeting) with the current battery power of the virtual reality device and enables/disables functions according to the option selected. In one or more embodiments, the system informs the user about the duration of the current power to complete the session in accordance with available settings of the interactive environment. Accordingly, this prevents the user from starting a session with interactive settings enabled on the virtual reality device and/or in the interactive digital environment, which then cause the virtual reality device to run out of battery power before the session is completed. For the remaining battery power, the system can display selectable options of activities for the virtual reality device and the session of the interactive digital environment in accordance with completion of the session or failing to complete the session. In response to a selection of one of the options, the systems causes the virtual reality device to operate in the session based on the selected option.

It is to be understood that although this disclosure includes a detailed description on cloud computing, implementation of the teachings recited herein are not limited to a cloud computing environment. Rather, embodiments of the present invention are capable of being implemented in conjunction with any other type of computing environment now known or later developed.

Cloud computing is a model of service delivery for enabling convenient, on-demand network access to a shared pool of configurable computing resources (e.g., networks, network bandwidth, servers, processing, memory, storage, applications, virtual machines, and services) that can be rapidly provisioned and released with minimal management effort or interaction with a provider of the service. This cloud model may include at least five characteristics, at least three service models, and at least four deployment models.

### Characteristics are as follows

On-demand self-service: a cloud consumer can unilaterally provision computing capabilities, such as server time and network storage, as needed automatically without requiring human interaction with the service’s provider.

Broad network access: capabilities are available over a network and accessed through standard mechanisms that promote use by heterogeneous thin or thick client platforms (e.g., mobile phones, laptops, and PDAs).

Resource pooling: the provider’s computing resources are pooled to serve multiple consumers using a multi-tenant model, with different physical and virtual resources dynamically assigned and reassigned according to demand. There is a sense of location independence in that the consumer generally has no control or knowledge over the exact location of the provided resources but may be able to specify location at a higher level of abstraction (e.g., country, state, or datacenter).

Rapid elasticity: capabilities can be rapidly and elastically provisioned, in some cases automatically, to quickly scale out and rapidly released to quickly scale in. To the consumer, the capabilities available for provisioning often appear to be unlimited and can be purchased in any quantity at any time.

Measured service: cloud systems automatically control and optimize resource use by leveraging a metering capability at some level of abstraction appropriate to the type of service (e.g., storage, processing, bandwidth, and active user accounts). Resource usage can be monitored, controlled, and reported, providing transparency for both the provider and consumer of the utilized service.

### Service Models are as follows

Software as a Service (SaaS): the capability provided to the consumer is to use the provider’s applications running on a cloud infrastructure. The applications are accessible from various client devices through a thin client interface such as a web browser (e.g., web-based e-mail). The consumer does not manage or control the underlying cloud infrastructure including network, servers, operating systems, storage, or even individual application capabilities, with the possible exception of limited user-specific application configuration settings.

Platform as a Service (PaaS): the capability provided to the consumer is to deploy onto the cloud infrastructure consumer-created or acquired applications created using programming languages and tools supported by the provider. The consumer does not manage or control the underlying cloud infrastructure including networks, servers, operating systems, or storage, but has control over the deployed applications and possibly application hosting environment configurations.

Infrastructure as a Service (IaaS): the capability provided to the consumer is to provision processing, storage, networks, and other fundamental computing resources where the consumer is able to deploy and run arbitrary software, which can include operating systems and applications. The consumer does not manage or control the underlying cloud infrastructure but has control over operating systems, storage, deployed applications, and possibly limited control of select networking components (e.g., host firewalls).

### Deployment Models are as follows

Private cloud: the cloud infrastructure is operated solely for an organization. It may be managed by the organization or a third party and may exist on-premises or off-premises.

Community cloud: the cloud infrastructure is shared by several organizations and supports a specific community that has shared concerns (e.g., mission, security requirements, policy, and compliance considerations). It may be managed by the organizations or a third party and may exist on-premises or off-premises.

Public cloud: the cloud infrastructure is made available to the general public or a large industry group and is owned by an organization selling cloud services.

Hybrid cloud: the cloud infrastructure is a composition of two or more clouds (private, community, or public) that remain unique entities but are bound together by standardized or proprietary technology that enables data and application portability (e.g., cloud bursting for load-balancing between clouds).

A cloud computing environment is service oriented with a focus on statelessness, low coupling, modularity, and semantic interoperability. At the heart of cloud computing is an infrastructure that includes a network of interconnected nodes.

Referring now to FIG. 8, illustrative cloud computing environment 50 is depicted. As shown, cloud computing environment 50 includes one or more cloud computing nodes 10 with which local computing devices used by cloud consumers, such as, for example, personal digital assistant (PDA) or cellular telephone 54A, desktop computer 54B, laptop computer 54C, and/or automobile computer system 54N may communicate. Nodes 10 may communicate with one another. They may be grouped (not shown) physically or virtually, in one or more networks, such as Private, Community, Public, or Hybrid clouds as described herein above, or a combination thereof. This allows cloud computing environment 50 to offer infrastructure, platforms and/or software as services for which a cloud consumer does not need to maintain resources on a local computing device. It is understood that the types of computing devices 54A-N shown in FIG. 8 are intended to be illustrative only and that computing nodes 10 and cloud computing environment 50 can communicate with any type of computerized device over any type of network and/or network addressable connection (e.g., using a web browser).

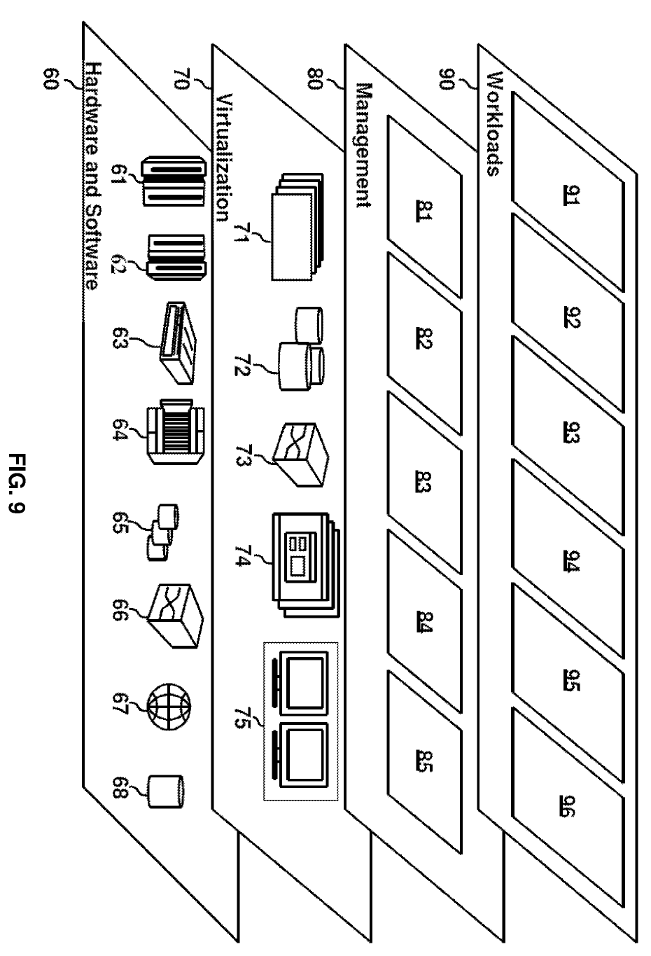

Referring now to FIG. 9, a set of functional abstraction layers provided by cloud computing environment 50 (depicted in FIG. 8) is shown. It should be understood in advance that the components, layers, and functions shown in FIG. 9 are intended to be illustrative only and embodiments of the invention are not limited thereto. As depicted, the following layers and corresponding functions are provided:

Hardware and software layer 60 includes hardware and software components. Examples of hardware components include: mainframes 61; RISC (Reduced Instruction Set Computer) architecture based servers 62; servers 63; blade servers 64; storage devices 65; and networks and networking components 66. In some embodiments, software components include network application server software 67 and database software 68.

Virtualization layer 70 provides an abstraction layer from which the following examples of virtual entities may be provided: virtual servers 71; virtual storage 72; virtual networks 73, including virtual private networks; virtual applications and operating systems 74; and virtual clients 75.

In one example, management layer 80 may provide the functions described below. Resource provisioning 81 provides dynamic procurement of computing resources and other resources that are utilized to perform tasks within the cloud computing environment. Metering and Pricing 82 provide cost tracking as resources are utilized within the cloud computing environment, and billing or invoicing for consumption of these resources. In one example, these resources may include application software licenses. Security provides identity verification for cloud consumers and tasks, as well as protection for data and other resources. User portal 83 provides access to the cloud computing environment for consumers and system administrators. Service level management 84 provides cloud computing resource allocation and management such that required service levels are met. Service Level Agreement (SLA) planning and fulfillment 85 provide pre-arrangement for, and procurement of, cloud computing resources for which a future requirement is anticipated in accordance with an SLA.

Workloads layer 90 provides examples of functionality for which the cloud computing environment may be utilized. Examples of workloads and functions which may be provided from this layer include: mapping and navigation 91; software development and lifecycle management 92; virtual classroom education delivery 93; data analytics processing 94; transaction processing 95; and workloads and functions 96. In one or more embodiments, the software 204 and (part of) the power management advisor module 248 can be implemented in the workloads and functions 96 to function as discussed herein.

Various embodiments of the present invention are described herein with reference to the related drawings. Alternative embodiments can be devised without departing from the scope of this invention. Although various connections and positional relationships (e.g., over, below, adjacent, etc.) are set forth between elements in the following description and in the drawings, persons skilled in the art will recognize that many of the positional relationships described herein are orientation-independent when the described functionality is maintained even though the orientation is changed. These connections and/or positional relationships, unless specified otherwise, can be direct or indirect, and the present invention is not intended to be limiting in this respect. Accordingly, a coupling of entities can refer to either a direct or an indirect coupling, and a positional relationship between entities can be a direct or indirect positional relationship. As an example of an indirect positional relationship, references in the present description to forming layer “A” over layer “B” include situations in which one or more intermediate layers (e.g., layer “C”) is between layer “A” and layer “B” as long as the relevant characteristics and functionalities of layer “A” and layer “B” are not substantially changed by the intermediate layer(s).

For the sake of brevity, conventional techniques related to making and using aspects of the invention may or may not be described in detail herein. In particular, various aspects of computing systems and specific computer programs to implement the various technical features described herein are well known. Accordingly, in the interest of brevity, many conventional implementation details are only mentioned briefly herein or are omitted entirely without providing the well-known system and/or process details.

In some embodiments, various functions or acts can take place at a given location and/or in connection with the operation of one or more apparatuses or systems. In some embodiments, a portion of a given function or act can be performed at a first device or location, and the remainder of the function or act can be performed at one or more additional devices or locations.

The terminology used herein is for the purpose of describing particular embodiments only and is not intended to be limiting. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, element components, and/or groups thereof.

The corresponding structures, materials, acts, and equivalents of all means or step plus function elements in the claims below are intended to include any structure, material, or act for performing the function in combination with other claimed elements as specifically claimed. The present disclosure has been presented for purposes of illustration and description but is not intended to be exhaustive or limited to the form disclosed. Many modifications and variations will be apparent to those of ordinary skill in the art without departing from the scope and spirit of the disclosure. The embodiments were chosen and described in order to best explain the principles of the disclosure and the practical application, and to enable others of ordinary skill in the art to understand the disclosure for various embodiments with various modifications as are suited to the particular use contemplated.

The diagrams depicted herein are illustrative. There can be many variations to the diagram or the steps (or operations) described therein without departing from the spirit of the disclosure. For instance, the actions can be performed in a differing order or actions can be added, deleted, or modified. Also, the term “coupled” describes having a signal path between two elements and does not imply a direct connection between the elements with no intervening elements/connections therebetween. All of these variations are considered a part of the present disclosure.

The following definitions and abbreviations are to be used for the interpretation of the claims and the specification. As used herein, the terms “comprises,” “comprising,” “includes,” “including,” “has,” “having,” “contains” or “containing,” or any other variation thereof, are intended to cover a non-exclusive inclusion. For example, a composition, a mixture, process, method, article, or apparatus that comprises a list of elements is not necessarily limited to only those elements but can include other elements not expressly listed or inherent to such composition, mixture, process, method, article, or apparatus.

Additionally, the term “exemplary” is used herein to mean “serving as an example, instance or illustration.” Any embodiment or design described herein as “exemplary” is not necessarily to be construed as preferred or advantageous over other embodiments or designs. The terms “at least one” and “one or more” are understood to include any integer number greater than or equal to one, i.e., one, two, three, four, etc. The terms “a plurality” are understood to include any integer number greater than or equal to two, i.e., two, three, four, five, etc. The term “connection” can include both an indirect “connection” and a direct “connection.”

The terms “about,” “substantially,” “approximately,” and variations thereof, are intended to include the degree of error associated with measurement of the particular quantity based upon the equipment available at the time of filing the application. For example, “about” can include a range of ± 8% or 5%, or 2% of a given value.

The present invention may be a system, a method, and/or a computer program product at any possible technical detail level of integration. The computer program product may include a computer readable storage medium (or media) having computer readable program instructions thereon for causing a processor to carry out aspects of the present invention.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, configuration data for integrated circuitry, or either source code or object code written in any combination of one or more programming languages, including an object oriented programming language such as Smalltalk, C++, or the like, and procedural programming languages, such as the "C" programming language or similar programming languages. The computer readable program instructions may execute entirely on the user’s computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instruction by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the blocks may occur out of the order noted in the Figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

The descriptions of the various embodiments of the present invention have been presented for purposes of illustration but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments described herein.

What is claimed is:

1. A computer-implemented method comprising:
obtaining a remaining power of a virtual device for engaging in an interactive digital environment, wherein the virtual device is configured to facilitate interactions associated with the interactive digital environment;
determining time periods for the interactions in accordance with the remaining power of the virtual device, wherein the time periods correlate to operational time of the virtual device for the interactions based on the remaining power of the virtual device;
presenting selectable options comprising the interactions juxtaposed with the time periods for operating the virtual device for the remaining power in the interactive digital environment; and
causing the virtual device to join the interactive digital environment with a selected option of the selectable options.

2. The computer-implemented method of claim 1, further comprising obtaining a duration of a session expected in the interactive digital environment.

3. The computer-implemented method of claim 1, wherein the determining the time periods for the interactions in accordance with the remaining power of the virtual device comprises determining the time periods for the interactions based on completing a duration of a session expected in the interactive digital environment.

4. The computer-implemented method of claim 1, wherein the determining the time periods for the interactions in accordance with the remaining power of the virtual device comprises obtaining digital environment factors for the interactive digital environment and determining the time periods for the interactions in accordance with the digital environment factors.

5. The computer-implemented method of claim 1, wherein in response to a duration of a session expected in the interactive digital environment, the selectable options display at least one interaction of the interactions having a time period that ensures the remaining power lasts for the duration of the session expected in the interactive digital environment.

6. The computer-implemented method of claim 1, wherein in response to a duration of a session expected in the interactive digital environment, the selectable options comprise the time periods indicating an extent the remaining power is expected to last for the duration of the session or when the remaining power is expected to fail during the duration of the session.

7. The computer-implemented method of claim 1, further comprising, in response to receiving the selected option of the selectable options, controlling the virtual device to operate at least one interaction of the interactions corresponding to the selected option in accordance with the remaining power of the virtual device.

8. A system comprising:
one or more memories having computer readable instructions; and
one or more processors for executing the computer readable instructions, the computer readable instructions controlling the one or more processors to perform operations comprising:
obtaining a remaining power of a virtual device for engaging in an interactive digital environment, wherein the virtual device is configured to facilitate interactions associated with the interactive digital environment;
determining time periods for the interactions in accordance with the remaining power of the virtual device, wherein the time periods correlate to operational time of the virtual device for the interactions based on the remaining power of the virtual device;
presenting selectable options comprising the interactions juxtaposed with the time periods for operating the virtual device for the remaining power in the interactive digital environment; and
causing the virtual device to join the interactive digital environment with a selected option of the selectable options.

9. The system of claim 8, wherein the one or more processors perform the operations further comprising obtaining a duration of a session expected in the interactive digital environment.

10. The system of claim 8, wherein the determining the time periods for the interactions in accordance with the remaining power of the virtual device comprises determining the time periods for the interactions based on completing a duration of a session expected in the interactive digital environment.

11. The system of claim 8, wherein the determining the time periods for the interactions in accordance with the remaining power of the virtual device comprises obtaining digital environment factors for the interactive digital environment and determining the time periods for the interactions in accordance with the digital environment factors.

12. The system of claim 8, wherein in response to a duration of a session expected in the interactive digital environment, the selectable options display at least one interaction of the interactions having a time period that ensures the remaining power lasts for the duration of the session expected in the interactive digital environment.

13. The system of claim 8, wherein in response to a duration of a session expected in the interactive digital environment, the selectable options comprise the time periods indicating an extent the remaining power is expected to last for the duration of the session or when the remaining power is expected to fail during the duration of the session.

14. The system of claim 8, wherein the one or more processors perform the operations further comprising, in response to receiving the selected option of the selectable options, controlling the virtual device to operate at least one interaction of the interactions corresponding to the selected option in accordance with the remaining power of the virtual device.

15. A computer program product comprising a computer readable storage medium having program instructions embodied therewith, the program instructions executable by one or more processors to cause the one or more processors to perform operations comprising:
obtaining a remaining power of a virtual device for engaging in an interactive digital environment, wherein the virtual device is configured to facilitate interactions associated with the interactive digital environment;
determining time periods for the interactions in accordance with the remaining power of the virtual device, wherein the time periods correlate to operational time of the virtual device for the interactions based on the remaining power of the virtual device;
presenting selectable options comprising the interactions juxtaposed with the time periods for operating the virtual device for the remaining power in the interactive digital environment; and
causing the virtual device to join the interactive digital environment with a selected option of the selectable options.

16. The computer program product of claim 15, wherein the one or more processors perform the operations further comprising obtaining a duration of a session expected in the interactive digital environment.

17. The computer program product of claim 15, wherein the determining the time periods for the interactions in accordance with the remaining power of the virtual device comprises determining the time periods for the interactions based on completing a duration of a session expected in the interactive digital environment.

18. The computer program product of claim 15, wherein the determining the time periods for the interactions in accordance with the remaining power of the virtual device comprises obtaining digital environment factors for the interactive digital environment and determining the time periods for the interactions in accordance with the digital environment factors.

19. The computer program product of claim 15, wherein in response to a duration of a session expected in the interactive digital environment, the selectable options display at least one interaction of the interactions having a time period that ensures the remaining power lasts for the duration of the session expected in the interactive digital environment.

20. The computer program product of claim 15, wherein in response to a duration of a session expected in the interactive digital environment, the selectable options comprise the time periods indicating an extent the remaining power is expected to last for the duration of the session or when the remaining power is expected to fail during the duration of the session.
